(19) United States
(12) Patent Application Publication
(10) Pub. No.: US 2016/0359348 A1
(43) Pub. Date: Dec. 8, 2016

(54) Novelty Charger Device

(71) Applicants: Tao Xu, Naperville, IL (US); Xiaojun Zhang, Shenzhen (CN); Linzhi Fang, Shenzhen (CN); Zhenjun Yang, Huizhou (CN)

(72) Inventors: Tao Xu, Naperville, IL (US); Xiaojun Zhang, Shenzhen (CN); Linzhi Fang, Shenzhen (CN); Zhenjun Yang, Huizhou (CN)

(21) Appl. No.: 14/732,768

(22) Filed: Jun. 7, 2015

(51) Int. Cl. H02J 7/00

(52) U.S. Cl. CPC H02J 7/0042

(57) ABSTRACT

Novelty charger devices provide users with a miniature portable battery for charging electronic devices such as smart phones and the like for up to roughly two hours of talking time. Further, the devices are designed to provide connector functionality for interconnecting, linking, or communicating electronic devices. Other features include device-locating functionality; visual alerts when the invention is distanced from a linked electronic device or when an incoming signal is detected; and built-in features for enabling remotely-controlled photographic capabilities. The novelty charger devices include a circuit assembly having a power source and at least one pivotal adapter element, and a housing assembly defining at least one adapter-receiving hollow construction. Each pivotal adapter element is pivotally receivable in an adapter-receiving hollow construction. The housing assembly encloses the power source, which source charges a select electronic device via the at least one pivotal adapter element when pivoted into a for-use configuration.

### BACKGROUND OF THE INVENTION

### Field of the Invention

The present invention generally relates to the field of accessories for electronic devices, and more particularly to novelty type charger and/or communication devices for electronic devices for charging and/or enabling communications between electronic devices.

### SUMMARY OF THE INVENTION

The present invention is primarily designed to provide users with a miniature portable battery or power source for charging electronic devices such as smart phones and the like for up to roughly two hours of talking time. Secondarily, the present invention is designed to provide connector functionality for interconnecting, linking, or communicating separate electronic devices. The present invention may thus function as a data cable or link between electronic devices such as a smart phone and a computer.

Other features of the present invention include (a) electronic device-locating functionality (e.g. through built-in Bluetooth capability); (b) visual alerts when the invention becomes distanced from a linked electronic device (e.g. through built-in Bluetooth capability) or when an incoming signal is detected (e.g. incoming calls or messages); and (c) built-in features for enabling remotely-controlled photographic capabilities (e.g. by sending signals to electronic devices outfitted with built-in camera features for prompting photography therefrom).

The present invention thus essentially provides a novelty charger device as variously exemplified for charging an electronic device such as a smart phone or a tablet type computer or for communicatively linking two such devices. A first novelty charger device according to the present invention may thus be said to preferably or essentially comprise a base construction, a circuit assembly, and a cover construction. The base construction preferably comprises a bottom portion and opposed end portions. The end portions extend away from the bottom portion, and at least one select basal portion comprises an adapter-receiving cavity, the at least one select basal portion being selected from the group consisting of the bottom and end portions.

The circuit assembly comprises a power source and at least one, but preferably two or first and second pivotal adapter elements. The power source and the at least one pivotal adapter element are in electrical communication via the circuit assembly with one another. The cover construction shrouds the circuit assembly and is attachable to the base construction such that the at least one or each pivotal adapter element is pivotally receivable in an adapter-receiving cavity. The cover construction is thus cooperable with the base construction for enclosing the power source intermediate the base and cover constructions. The enclosed power source may thus function to charge a select electronic device via the at least one pivotal adapter element.

The at least one select basal portion may preferably comprise at least two select basal portions. The at least two select basal portions are selected from the group consisting of the bottom portion and at least one of the end portions. The circuit assembly may thus also comprise at least two pivotal adapter elements, which two pivotal adapter elements are pivotally receivable in at least two adapter-receiving cavities. When so configured, the novelty charger device may thus further communicate at least two electronic devices.

The at least two pivotal adapter elements each comprise a pivot axis, which pivot axes are preferably parallel to one another. A first pivot axis enables rotation of a first pivotal adapter element through at least 180 rotational degrees and a second pivot axis enables rotation of a second pivotal adapter element through at least 90 rotational degrees. The first and second pivotal adapter elements may thus extend in opposite directions relative to the base construction when pivoted to a fully extended for-use configuration.

The bottom portion preferably comprises outer bottom surfacing and a first select end portion as selected from the end portions preferably comprises outer first select end portion surfacing. The first and second pivotal adapter elements each comprise outer adapter surfacing. The outer bottom and first select end portion surfacing are flush with the outer adapter surfacing when the first and second pivotal adapter elements are in a closed position or configuration.

The circuit assembly may preferably comprise a switch for enabling various types of functions, and thus a switch-activating button is further contemplated. A second select end portion as selected from the end portions comprises a button-receiving aperture. The switch-activating button is receivable in the button-receiving aperture and is communicable with the switch of the circuit assembly for enabling button-actuable functionality of the novelty charger device.

The switch-activating button comprises outer button surfacing and the second select end portion comprises outer second select end portion surfacing. The outer button surfacing is flush with the outer second select end portion surfacing when the switch-activating button is in a relaxed or non-depressed state or configuration. The power source may preferably comprise a cylindrical outer surface and the cover construction may preferably comprise a U-shaped transverse cross-section. The U-shaped transverse cross-section thus provides an arcuate shroud over the power source via a semi-cylindrical upper portion of the cover construction.

Another novelty charger device according to the present invention may be said to provide functionality for charging an electronic device, and may be said to preferably or essentially comprise an adapter-circuit mount, a circuit assembly, and a fanciful or amusing housing assembly. The adapter-circuit mount preferably comprising an adapter-receiving hollow construction, which adapter-receiving hollow construction comprises a base portion and opposed wall portions. The wall portions extend from the base portion. The circuit assembly comprises a power source and at least one pivotal adapter element. The power source and the at least one pivotal adapter element are in electrical communication with one another.

The fanciful or amusing housing assembly preferably and essentially comprises a mount-adapter-cover assembly. The circuit assembly is cooperable with the adapter-circuit mount such that the at least one pivotal adapter element is pivotally receivable in the adapter-receiving hollow construction. The fanciful or amusing housing assembly is cooperable with the adapter-circuit mount for enclosing the power source within the fanciful or amusing housing assembly. The power source may thus be used to charge a select electronic device via the at least one pivotal adapter element when pivoted into a for-use configuration.

This novelty charger device may also preferably comprise at least two pivotal adapter elements, which at least two pivotal adapter elements each are pivotally receivable in the adapter-receiving hollow construction. The novelty charger device may thus provide further functionality for communicating at least two electronic devices.

The fanciful or amusing housing assembly of the novelty charger device may preferably comprise a hollow cover element, which hollow cover element is displaceable relative to the mount-adapter-cover assembly for selectively exposing the adapter-receiving hollow construction and enabling each pivotal adapter element to pivot from a “for-storage” configuration to a “for-use” configuration. Each of the two pivotal adapter elements comprise a pivot axis, which pivot axes are preferably parallel to one another and extend orthogonally relative to the parallel wall portions.

Yet another novelty charger device according to the present invention may function to charge an electronic device or link or communicate two electronic devices. This novelty charger device may be said to preferably comprise a circuit assembly and a fanciful or amusing housing assembly, wherein the circuit assembly comprises a power source and at least one pivotal adapter element, the power source and the at least one pivotal adapter element being in electrical communication with one another.

The fanciful or amusing housing assembly of this novelty charger device may be said to preferably comprise an adapter-circuit mount and a mount-adapter-cover assembly. The adapter-circuit mount defines an adapter-receiving hollow construction, and the circuit assembly is cooperable with the adapter-circuit mount such that the at least one pivotal adapter element is pivotally receivable in the adapter-receiving hollow construction. The fanciful or amusing housing assembly is cooperable with the adapter-circuit mount for enclosing the power source within the housing assembly, and the novelty-enclosed power source thus for charging a select electronic device via the at least one pivotal adapter element when pivoted into a for-use configuration.

Other features and objects of the novelty charger devices according to the present invention will become more evident from a consideration of the following brief descriptions of patent drawings submitted in support of these specifications.

### BRIEF DESCRIPTION OF THE DRAWINGS

FIG. 1 is a top posterior end perspective view of a first novelty charger device according to the present invention depicted in a fully closed configuration.

FIG. 2 is a top anterior end perspective view of the first novelty charger device according to the present invention depicted in the fully closed configuration.

FIG. 3 is a top posterior end perspective view of the first novelty charger device according to the present invention depicted in a first partially open-partially closed configuration.

FIG. 4 is a bottom anterior end perspective view of the first novelty charger device according to the present invention depicted in a second partially open-partially closed configuration.

FIG. 5 is a top perspective view of the first novelty charger device according to the present invention depicted in a fully open “for-use” configuration.

FIG. 6 is an exploded top anterior end perspective view of the first novelty charger device according to the present invention.

FIG. 7 is an exploded top posterior end perspective view of the first novelty charger device according to the present invention.

FIG. 8 is an enlarged top anterior end perspective view of a base construction of the first novelty charger device according to the present invention.

FIG. 9 is an exploded bottom posterior end perspective view of a cover assembly of the first novelty charger device according to the present invention.

FIG. 10 is an enlarged top anterior end perspective view of a circuit assembly of the first novelty charger device according to the present invention.

FIG. 11 is an enlarged top posterior end perspective view of the circuit assembly of the first novelty charger device according to the present invention.

FIG. 12 is an enlarged longitudinal cross-sectional view of an assembled first novelty charger device according to the present invention depicted in the fully closed configuration.

FIG. 13 is an enlarged anterior elevational view of the first novelty charger device according to the present invention depicted in a closed configuration.

FIG. 14 is a top, first, button side perspective view of a second novelty charger device according to the present invention depicted in a fully closed configuration.

FIG. 15 is a top, second, side perspective view of the second novelty charger device according to the present invention depicted in the fully closed configuration.

FIG. 16 is a bottom, third, cover side perspective view of the second novelty charger device according to the present invention depicted in the fully closed configuration.

FIG. 17 is a bottom, first, button side perspective view of the second novelty charger device according to the present invention depicted in the fully closed configuration.

FIG. 18 is a bottom, third, cover side perspective view of the second novelty charger device according to the present invention depicted in a fully open configuration.

FIG. 19 is a top, first, button side perspective view of the second novelty charger device according to the present invention depicted in a fully open configuration.

FIG. 20 is a bottom, first, button side perspective view of the second novelty charger device according to the present invention depicted in a first partially open-partially closed configuration.

FIG. 21 is a top, first, button side perspective view of the second novelty charger device according to the present invention depicted in the first partially open-partially closed configuration.

FIG. 22 is a top, first, button side perspective view of the second novelty charger device according to the present invention depicted in a second partially open-partially closed configuration.

FIG. 23 is a bottom, third, cover side perspective view of the second novelty charger device according to the present invention depicted in the second partially open-partially closed configuration.

FIG. 24 is a top exploded perspective view of the second novelty charger device according to the present invention.

FIG. 25A is a first enlarged end view of an adapter-circuit mount construction of the second novelty charger device according to the present invention depicted without first and second pivotal adapter elements installed.

FIG. 25B is a second enlarged end view of the adapter-circuit mount construction of the second novelty charger device according to the present invention depicted with first and second pivotal adapter elements installed.

FIG. 26A is an enlarged first cross-sectional view of the second novelty charger device according to the present invention sectioned through a first dimension.

FIG. 26B is an enlarged second cross-sectional view of the second novelty charger device according to the present invention sectioned through a second dimension orthogonal to the first dimension.

FIG. 27 is a top anterior perspective view of a third novelty charger device according to the present invention depicted in a fully closed configuration.

FIG. 28 is a top posterior perspective view of the third novelty charger device according to the present invention depicted in the fully closed configuration.

FIG. 29 is a bottom anterior perspective view of the third novelty charger device according to the present invention depicted in the fully closed configuration.

FIG. 30 is a bottom posterior perspective view of the third novelty charger device according to the present invention depicted in the fully closed configuration.

FIG. 31 is a posterior perspective view of the third novelty charger device according to the present invention depicted in the fully open configuration.

FIG. 32 is an anterior perspective view of the third novelty charger device according to the present invention depicted in the fully open configuration.

FIG. 33 is a posterior perspective view of the third novelty charger device according to the present invention depicted in a first partially open-partially closed configuration.

FIG. 34 is an anterior perspective view of the third novelty charger device according to the present invention depicted in the first partially open-partially closed configuration.

FIG. 35 is a posterior perspective view of the third novelty charger device according to the present invention depicted in a second partially open-partially closed configuration.

FIG. 36 is an anterior perspective view of the third novelty charger device according to the present invention depicted in the second partially open-partially closed configuration.

FIG. 37 is a top anterior exploded perspective view of the third novelty charger device according to the present invention.

FIG. 38A is an enlarged first cross-sectional view of the third novelty charger device according to the present invention sectioned through a first dimension.

FIG. 38B is an enlarged second cross-sectional view of the third novelty charger device according to the present invention sectioned through a second dimension orthogonal to the first dimension.

FIG. 39 is a schematic side view depiction of the first novelty charger device according to the present invention shown connected to a generic first electronic device via a first adapter element of the first novelty charger device for charging the generic first electronic device.

FIG. 40 is a schematic side view depiction of the second novelty charger device according to the present invention shown connected to the generic first electronic device via a first adapter element of the second novelty charger device for charging the generic first electronic device.

FIG. 41 is a schematic side view depiction of the third novelty charger device according to the present invention shown connected to the generic first electronic device via a first adapter element of the third novelty charger device for charging the generic first electronic device.

FIG. 42 is a schematic side view depiction of the first novelty charger device according to the present invention shown connected to (a) the generic first electronic device via the first adapter element of the first novelty charger device and (b) a generic second electronic device via a second adapter element of the first novelty charger device for electronically communicating the first and second generic electronic devices.

### DETAILED DESCRIPTION OF THE PREFERRED EMBODIMENT(S)

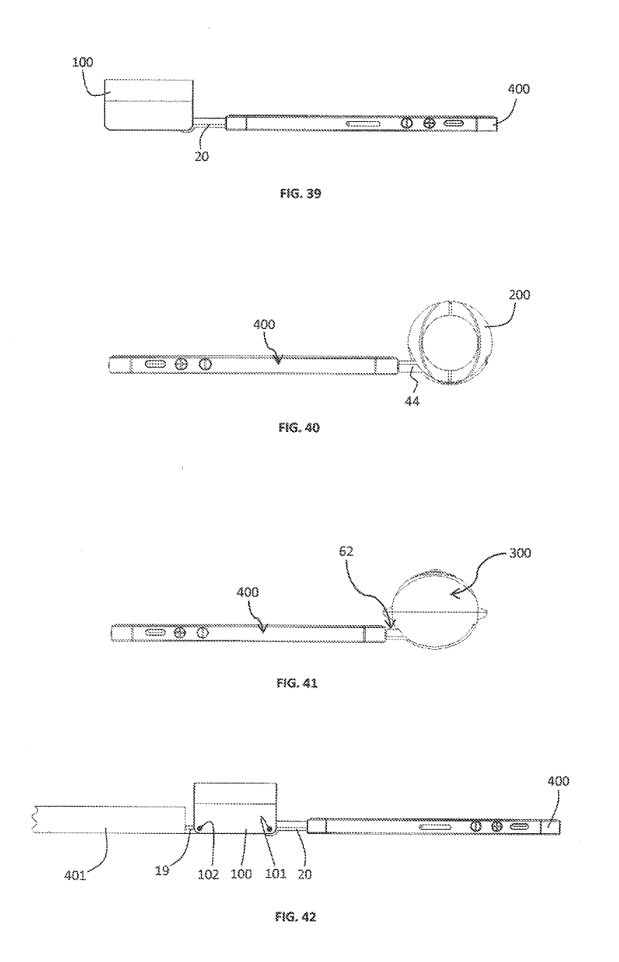

Referring now the drawings with more specificity, the preferred embodiment of the present invention basically provides a novelty charger device as variously exemplified at 100 (e.g. a mailbox version), 200 (e.g. a ball version), and 300 (e.g. a toy head version) for charging an electronic device such as a smart phone as at 400 or similar other electronic device for up to roughly two hours of talking or use time. Secondarily, the present invention is designed to provide connector functionality for interconnecting, linking, or communicating separate electronic devices as for example a smart phone 400 and a tablet computer or laptop computer as generically referenced at 401. The present invention may thus function as a data cable or link between electronic devices such as a smart phone 400 and a computer 401 as generally depicted in FIG. 42.

Other features of the present invention include (a) electronic device-locating functionality (e.g. as enabled by way of built-in Bluetooth capability); (b) visual (LED) alerts when the invention becomes distanced from a linked electronic device (e.g. as enabled by way of built-in Bluetooth capability) or when an incoming signal is detected (e.g. incoming calls or messages); and (c) built-in features for enabling remotely-controlled photographic capabilities (e.g. by selectively sending wired or wireless signals to electronic devices outfitted with built-in camera features for prompting photography therefrom). All of the devices 100, 200, and 300 may be preferably outfitted with device-based apertures 70 for attaching a lanyard, key ring, or some other hardware for enabling the user to easily carry the device(s) 100, 200, and/or 300 as a fob like device.

The novelty charger device 100 according to the present invention may be referred to as the “mailbox” version in view of its overall visual similarity to a traditional mailbox shape. It is believed that the mailbox shape itself provides unique form and function for a novelty charger device insofar as the form provides a flat lower surface for support upon a planar support surface, and a rounded upper surface for shroud-protecting a cylindrical inner battery element as at 18.

The novelty charger device 100 according to the present invention thus preferably comprises a base construction as at 10, a circuit assembly as at 11, and a cover construction as at 12. The base construction 10 preferably comprises a bottom portion as at 13 and opposed end portions as at 14 and 15. The bottom portion 13 of the base construction 10 preferably comprises outer bottom surfacing as at 22.

The end portions 14 and 15 preferably extend in parallel relation to one another and generally orthogonally relative to the bottom portion 13. A select first end portion as selected from the group consisting of the end portions 14 and 15, preferably comprises a first adapter-receiving cavity as at 16, which, in the illustrated embodiment, is formed in end portion 15. The bottom portion 13 preferably comprises a second adapter-receiving cavity as at 17.

The circuit assembly 11 preferably comprises a power source such as a rechargeable battery element as at 18; a first (e.g. a Universal Serial Bus or USB) adapter as at 19, and a second (e.g. a lightening by Apple, Inc.) adapter as at 20. The power source as exemplified by a (cylindrical) electrochemical and rechargeable battery 18, and the first and second adapters 19 and 20 are in electrical communication with one another via conductors or wires as at 21. The first and second adapters 19 and 20 are respectively pivotal about first and second pivot axes of rotation as at 101 and 102, which first and second pivot axes 101 and 102 are preferably parallel to one another.

The circuit assembly 11 may further preferably comprise a switch as at 26 and the device 100 may further comprise a switch-activating button assembly including a button as at 27 and a button holder construction as at 28. A second select end portion as exemplified by end portion 14 preferably comprises a button-receiving aperture as at 29. The switch-activating button 27 is receivable in the button-receiving aperture 29 and communicable with the switch 26 for enabling button-actuable functionality of the charger device 100.

In keeping with the notion that the novelty charger device(s) according to the present invention provide the appearance of some form of novelty item while simultaneously housing charger functionality, the button 27 preferably comprises certain outer button surfacing as at 36, and the second select end portion comprises certain outer second end portion surfacing as at 37. The outer button surfacing 35 is preferably flush with the outer second end portion surfacing 37 when the button 27 is in a relaxed or non-depressed state or configuration.

A Printed Circuit Board Assembly or PCBA as at 30; a Printed Control Module or PCM board as at 31; a Flexible Printed Circuit or FPC 32; a series of Light Emitting Diodes or LED's 33; and a Bluetooth module 34 may be further preferably incorporated into the circuit assembly 11 for enabling enhanced functionality.

The first pivot axis 101 or that axis associated with the first adapter 19 enables rotation of the first adapter 19 through at least 90 degrees from a fully closed state or configuration to a fully open state or for-use configuration. The first adapter 19 is prevented from rotation past 180 rotational degrees by the provision or incorporation of a stop mechanism as at 41. By contrast, the pivot axis 102 or that axis associated with the second adapter 20 enables rotation of the second adapter 20 through at least 180 degrees from a fully closed state or configuration to a fully open state or for-use configuration.

When the first adapter 19 is pivoted 90 degrees from the fully closed state to an open state and the second adapter 20 is pivoted 90 degrees from the fully closed state to an open state, the first and second adapters 19 and 20 extend in opposite directions relative to the base construction 10 or 180 degrees relative to one another when so pivoted.

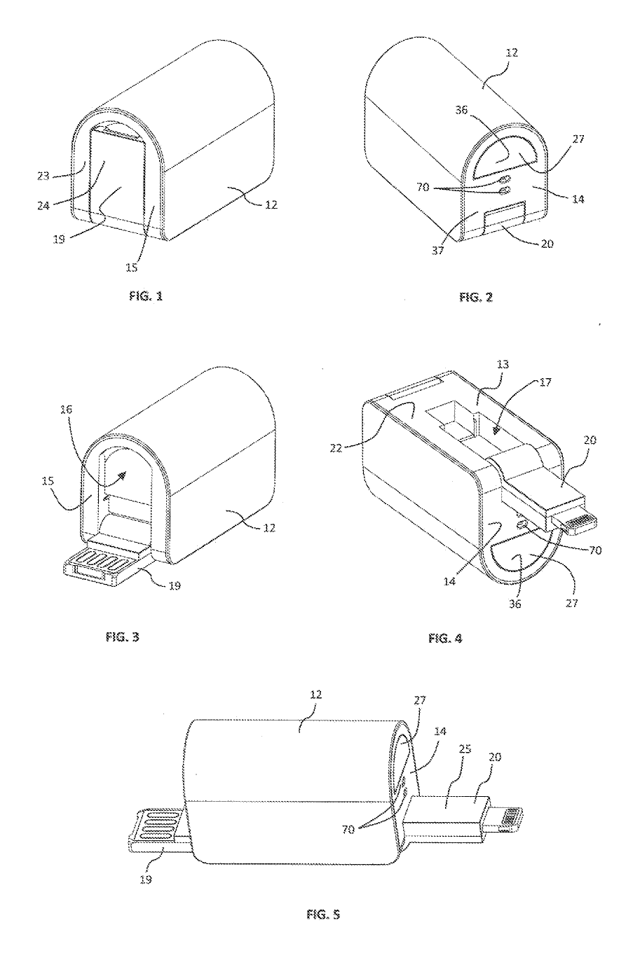

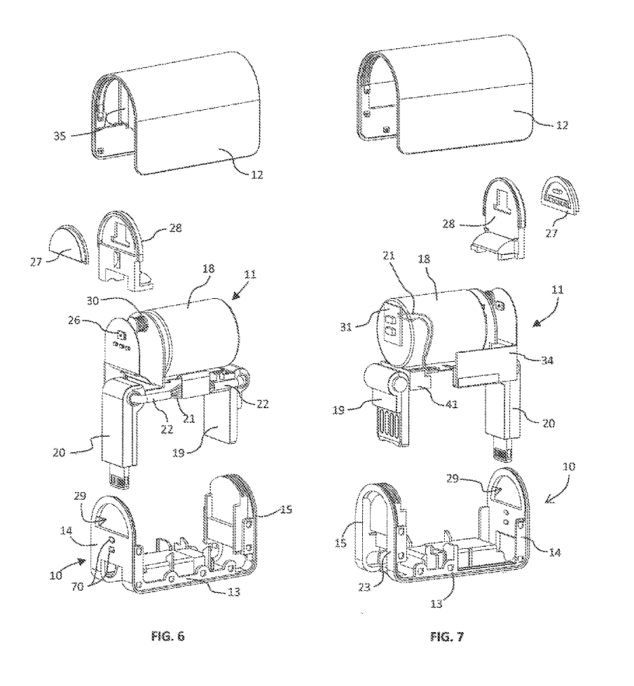

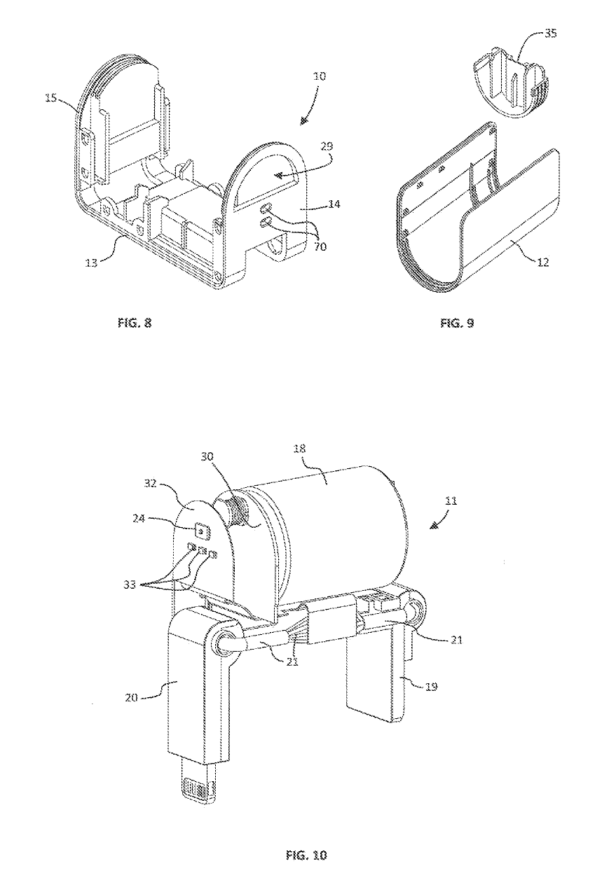

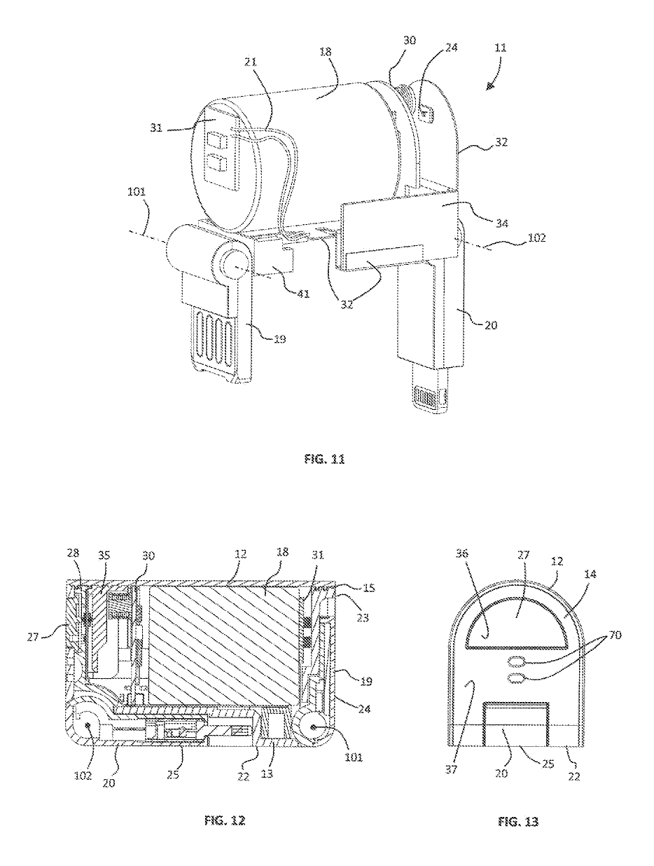

The circuit assembly 11 is cooperably assembled with the base construction 10 such that the first and second adapters 19 and 20 are pivotally receivable in the first and second adapter-receiving cavities 16 and 17 when in a closed state or configuration as generally depicted in FIG. 1, 2, and 12. The first select end portion as at 15 preferably comprises outer first end portion surfacing as at 23, and the first and second adapters 19 and 20 each preferably comprise outer adapter surfacing as at 24 and 25 respectively. The outer bottom surfacing 22 and the first end portion surfacing 23 are preferably flush with the outer adapter surfacing 24 and 25 when the first and second adapters 19 and 20 are pivoted to the closed position or configuration as generally depicted in FIG. 12.

The cover assembly or construction 12 may preferably include or comprise a cover bracket as at 35 and together the cover assembly or construction 12 is cooperably assembled with the base construction 10 for enclosing the power source or battery 18 intermediate the base and cover constructions 10 and 12. The power source or battery 18 may thus function to charge an adapter-connected device as at 400 via at least one of the first or second adapters 19 and/or 20 as generally depicted in FIG. 39. When the button 27 is relaxed and the adapters 19 and 20 are in a closed configuration, it will thus be seen that the novelty charger device 100 resembles a traditional mailbox shape (including a cuboid lower half and a semi-cylindrical upper half) novelty charger device. As earlier indicated, the novelty charger device 100 may include a power source or battery element comprising a cylindrical outer surface and the cover construction 12 may preferably comprise a U-shaped transverse cross-section for providing an arcuate shroud over the power source or battery element.

Similar to novelty charger device 100, the novelty charger device 200 basically functions to enable a user to charge an electronic device such as a smart phone as generically depicted and referenced at 400 as generally depicted in FIG. 40. In structural distinction to the novelty charger device 100, however, the novelty charger device 200 preferably comprises an adapter-circuit mount as at 38; a circuit assembly with various components; and a fanciful or amusing housing assembly with various components.

Central to the construction of the novelty charger device 200 is the adapter-circuit mount 38 which mount 38 preferably comprises an adapter-receiving hollow construction including a base portion as at 39 and opposed wall portions as at 40 on a first side thereof and a power source-receiving construction on a second side thereof, including cylinder-holding projections as at 52. It will thus be understood that the power-source receiving construction as here exemplified is structurally located opposite the adapter-receiving hollow construction 42 of the adapter-circuit mount 38.

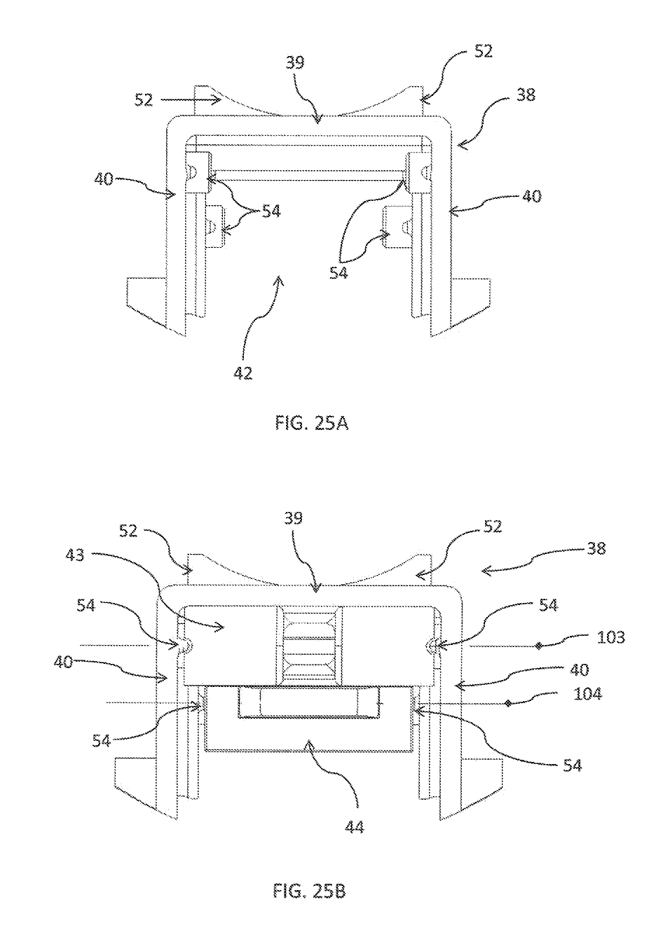

The wall portions 40 extend from the base portion 39 and thus form a generally Π-shaped transverse cross-section, the space intermediate the walls 40 and base portion 39 forming an adapter-receiving hollow as at 42. Comparatively referencing FIG. 25A and 25B, the reader will there see before and after views of the hollow construction 42 that receives first and second adapters 43 and 44 of the circuit assembly.

The reader will thus consider that the circuit assembly of the novelty charger device 200 is substantially similar to the circuit assembly of the novelty charger device 100, and thus preferably and essentially comprises a power source as exemplified by a battery as at 18, a first (e.g. USB type) adapter as at 43, and a second (e.g. APPLE, INC. lightning type) adapter as at 44. As illustrated, the circuit assembly of the novelty charger device 200 further contemplates, includes, or incorporates a PCBA element 45 and a Bluetooth module 46 for enabling enhanced functionality.

The power source as exemplified by the battery element 18 and the first and second adapters 43 and 44 are in electrical communication with one another through conductors such as wires (not specifically illustrated), and the first and second adapters 43 and 44 are respectively pivotal about first and second pivot axes of rotation as at 103 and 104, respectively, for selectively distending the first and/or second adapters from the fanciful or amusing housing assembly for charging and/or linking electronic devices.

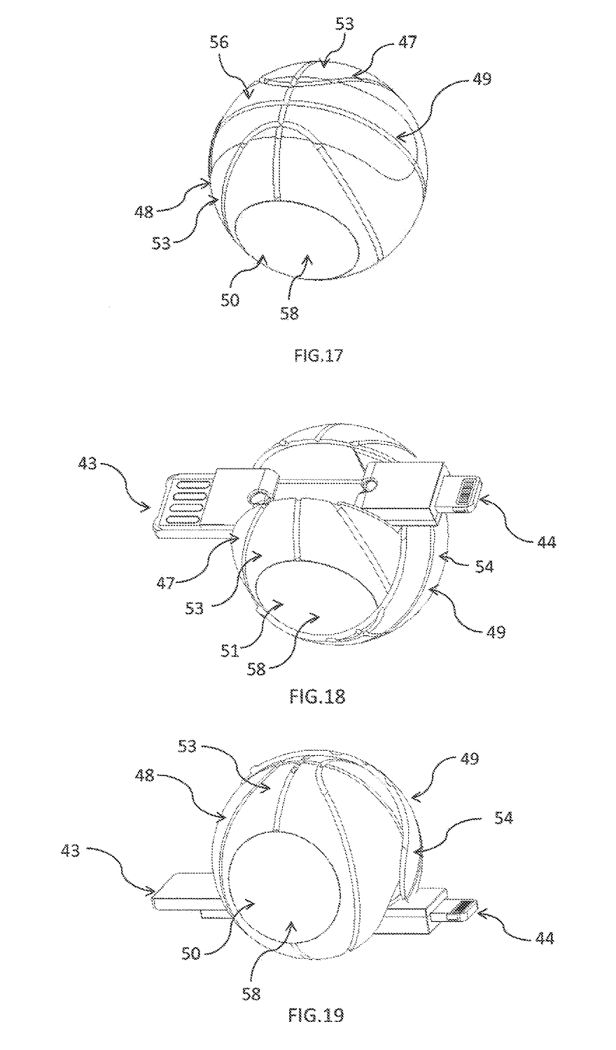

The first and second pivot axes 103 and 104 preferably extend in parallel relation to one another orthogonally relative to the wall portions 40 and both axes enable rotation of the adapters through at least 180 degrees from the for-use configuration to a closed configuration within the adapter-receiving hollow construction 42. In this regard, the walls 40 of the adapter-circuit mount 38 may preferably comprise either male or female structures (male structures 54 are illustrated) matable with female or male structures formed on the first and second adapters 43 and 44 (female structures 55 are illustrated) for enabling pivotal movement about the axes 103 and 104 when mated therewith. The first and second adapters 43 and 44 extend in opposite directions relative to the adapter-circuit mount 38 when pivoted to a fully extended state as generally depicted in FIG. 18 and 19.

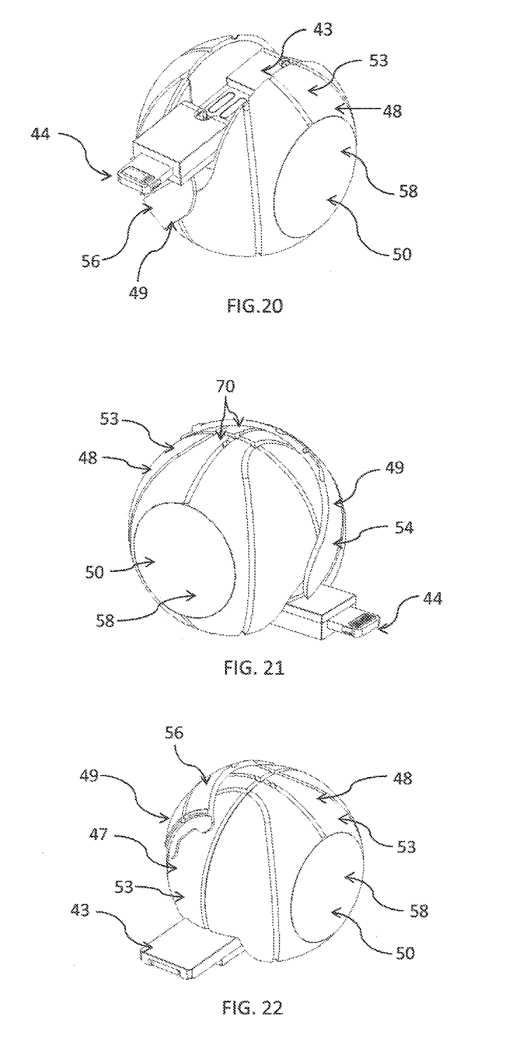

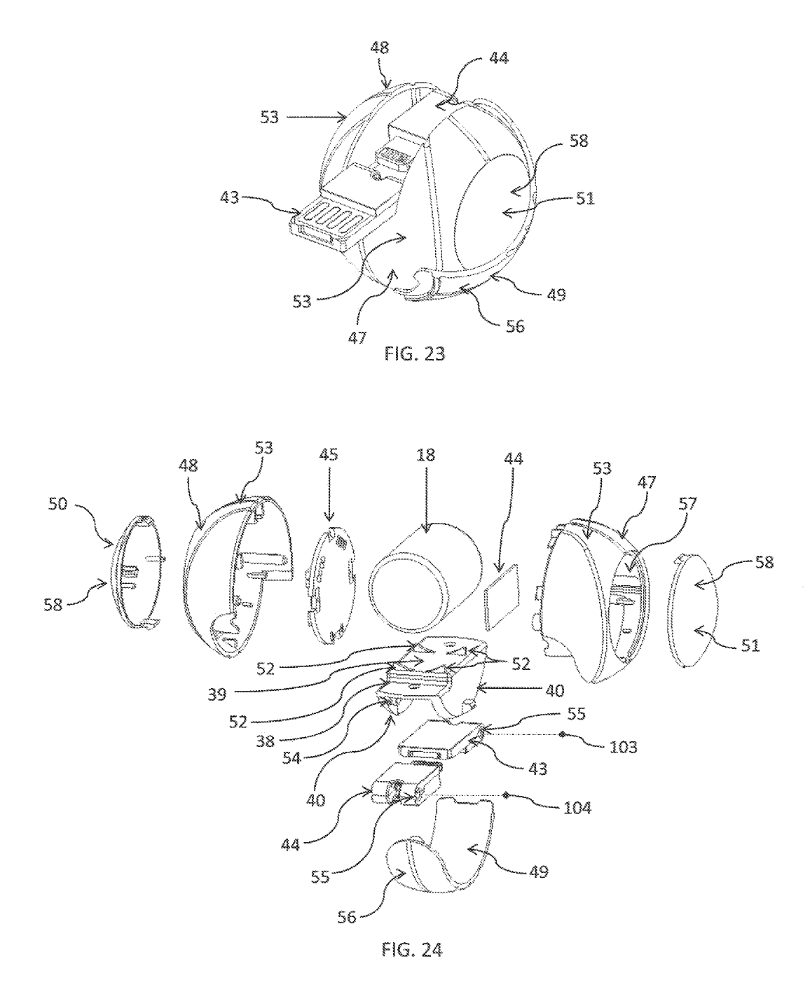

The fanciful or amusing housing assembly of the novelty charger device 200 preferably comprises a mount-adapter-cover assembly including a first cover element or half as at 47, a second cover element or half as at 48, a combination removable first logo cover and push button assembly 50 (communicable with a switch of the circuit assembly), a removable second logo cover 51. The fanciful or amusing housing assembly further comprises a hollow cover element 49 that is displaceable relative to the outer assembly surfacing 53 of the first and second cover elements 47 and 48 for enabling access to the first and second adapters 43 and 44 and the adapter-receiving hollow construction 42 and enabling the first and second adapters 43 and 44 to pivot about the first and second pivot axes 103 and 104 into a for-use configuration as generally and comparatively depicted in FIG. 18-23.

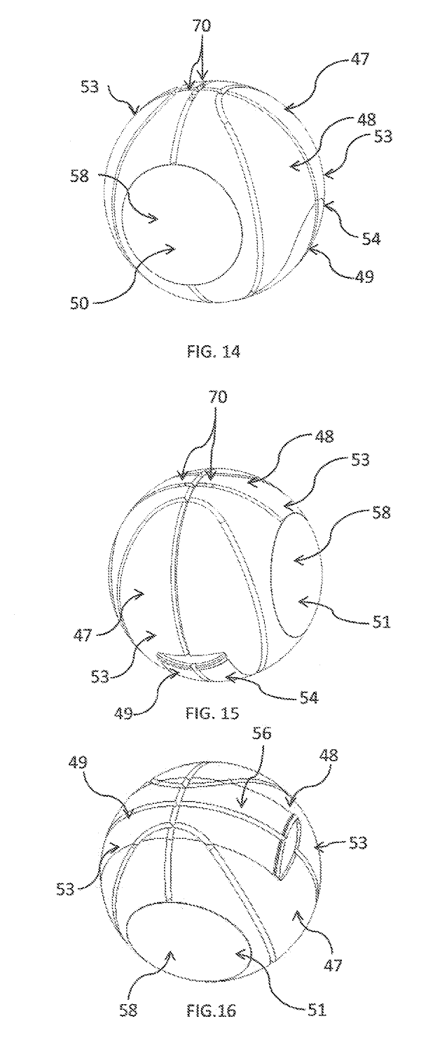

As indicated, the mount-adapter-cover assembly comprises outer assembly surfacing as at 53. The hollow cover element 49 preferably and similarly comprises outer cover surfacing as at 56. The outer assembly surfacing 53 and the outer cover surfacing 56 are preferably flush when the novelty charger device 200 is in a fully closed configuration as generally depicted in FIG. 14-17. The circuit assembly is cooperably assembled with the adapter-circuit mount 38 such that the first and second adapters 43 and 44 are pivotally receivable in the adapter-receiving hollow construction 42 when in a closed configuration.

The fanciful or amusing housing assembly is cooperably assembled with the adapter-circuit mount 38 for enclosing the power source intermediate the adapter-circuit mount 38 and the first and second cover elements 47 and 48 of the mount-adapter-covering assembly. The power source may thus effectively function to charge a select electronic device via at least one of the first or second adapters 43 and/or 44 when pivoted into a for-use configuration as generally depicted in FIG. No 40.

As indicated, the combination logo cover-button 50 is preferably switch-activating. The circuit assembly of the novelty charger device 200 may thus preferably comprise a switch, and the second cover element or half 48 of the mount-adapter-cover assembly preferably comprises a button-receiving aperture. The switch-activating button 50 is receivable in the button-receiving aperture and communicable with the switch for enabling button-actuable functionality of the novelty charger device 200. The button-receiving aperture is akin to aperture 57 formed in the first cover element or half 47, which aperture functions to receive the logo cover element 51.

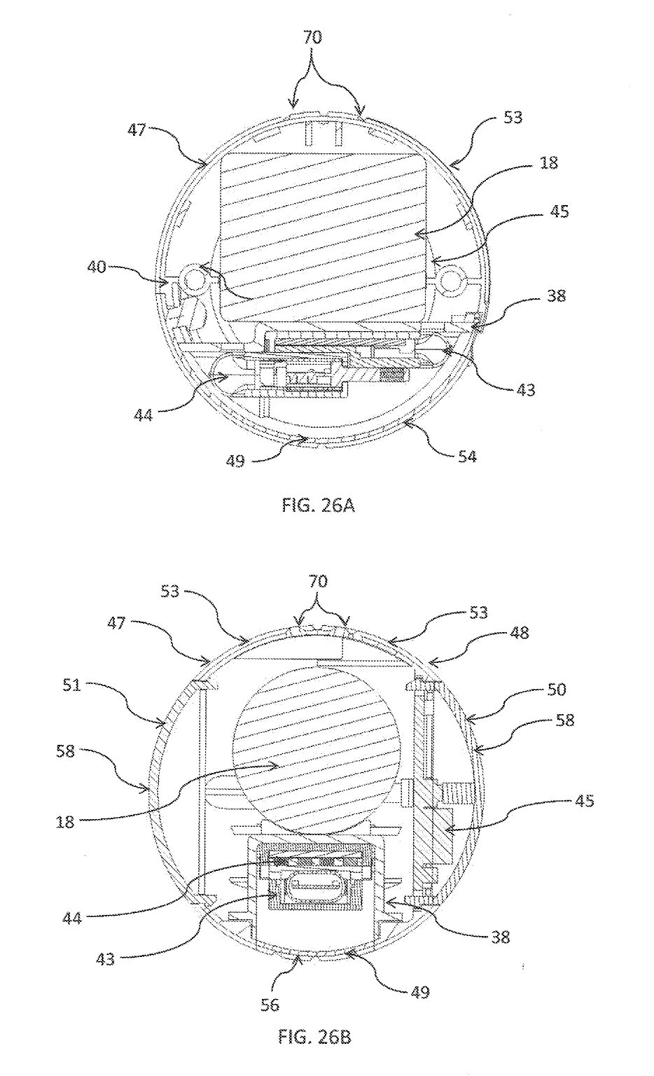

The combination logo cover-button 50 and the cover element 51 both preferably comprise outer button or cover surfacing as at 58, which outer button or cover surfacing 58 is preferably flush with the outer assembly surfacing 53 when the button 50 is in a relaxed or non-depressed state or configuration as generally depicted in FIG. 26B. When the button 50 is relaxed and the hollow cover element 49 is in a closed configuration, it will thus be seen that the novelty charger device 200 is preferably spherical in overall form for resembling a ball-shaped novelty charger device.

The novelty charger device 300 is relatively more structurally and functionally similar to the novelty charger device 200 as compared to the novelty charger device 100, but also basically functions to charge an electronic device (as at 400 or 401) such as a smart phone or tablet type computer as generally depicted in FIG. 41, and/or link two such devices. To achieve these primary objectives, the novelty charger device 300 according to the present invention preferably comprises a fanciful or amusing housing assembly comprising or defining an adapter-circuit mount construction, and a circuit assembly cooperable therewith.

The adapter-circuit mount construction formed or provided by the fanciful or amusing housing assembly of the novelty charger device 300 defines an adapter-receiving hollow or cavity construction as at 59. The hollow or cavity construction 59 of the device 300 is formed as part of a rear cover element 60 of the fanciful or amusing housing assembly.

As with the devices 100 and 200, the circuit assembly of the novelty charger device 300 preferably comprises a power source as exemplified by a rechargeable battery as at 18, a first (e.g. USB) adapter as at 61, and a second (e.g. Apple, Inc. lightning type) adapter as at 62. The power source or battery 18, and the first and second adapters 61 and 62 are in electrical communication with one another, and the first and second adapters are respectively pivotal about first and second pivot axes of rotation as at 105 and 106. As illustrated, the circuit assembly of the novelty charger device 300 further contemplates, includes, or incorporates a PCBA element 67 and a Bluetooth module 68 for enabling enhanced functionality.

The fanciful or amusing housing assembly further comprises a front cover element 63, and a hollow cover element 64 cooperatively associated with the rear cover element 60 for selectively enabling access to the adapter-receiving hollow construction 59 and hollow-received adapters 61 and 62 as pivotally received therein. The circuit assembly of the novelty charger device 300 is cooperably assembled with the adapter-circuit mount portion of the fanciful or amusing housing assembly such that the first and second adapters 61 and 62 are pivotally receivable in the adapter-receiving hollow construction 59 when the device 300 is placed into a closed state or configuration.

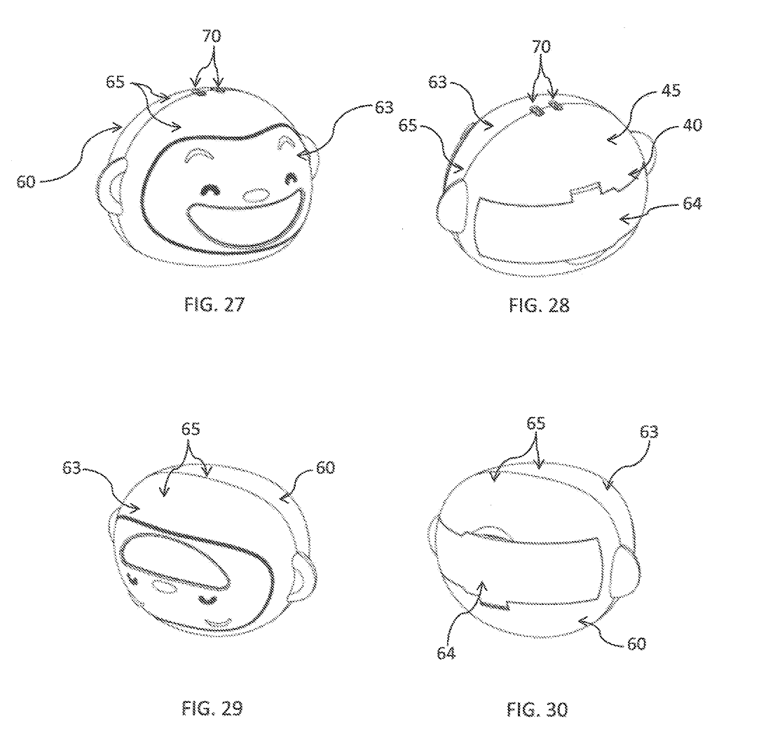

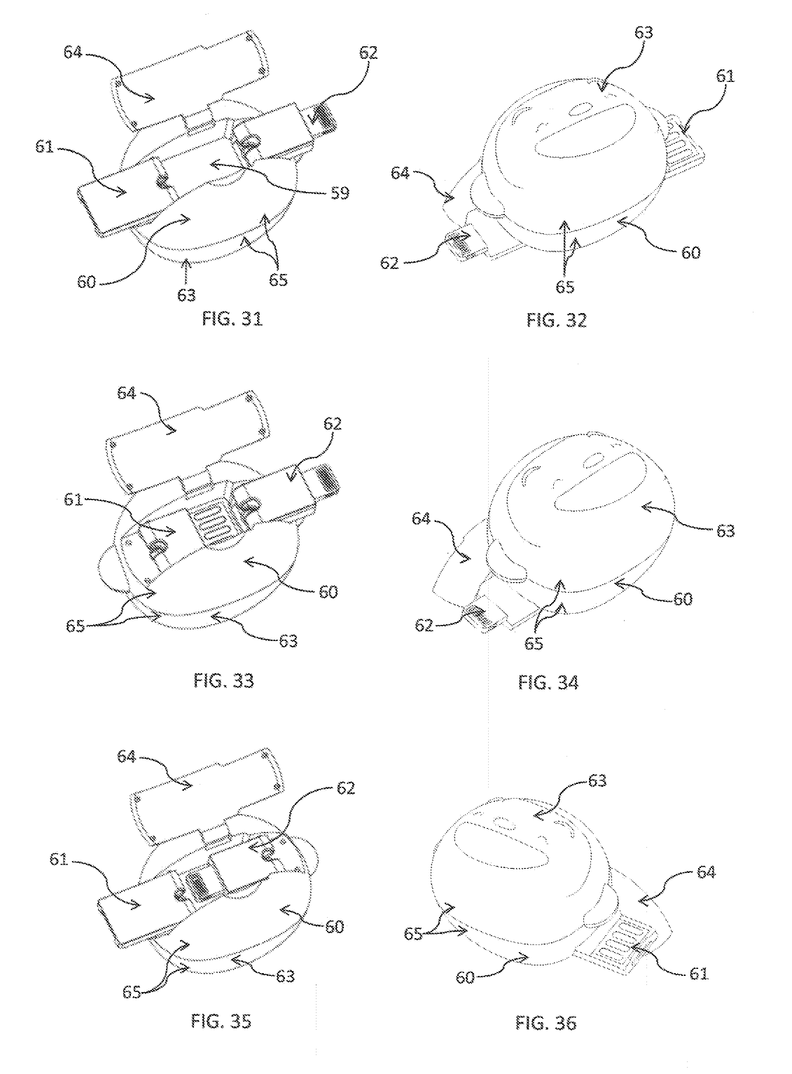

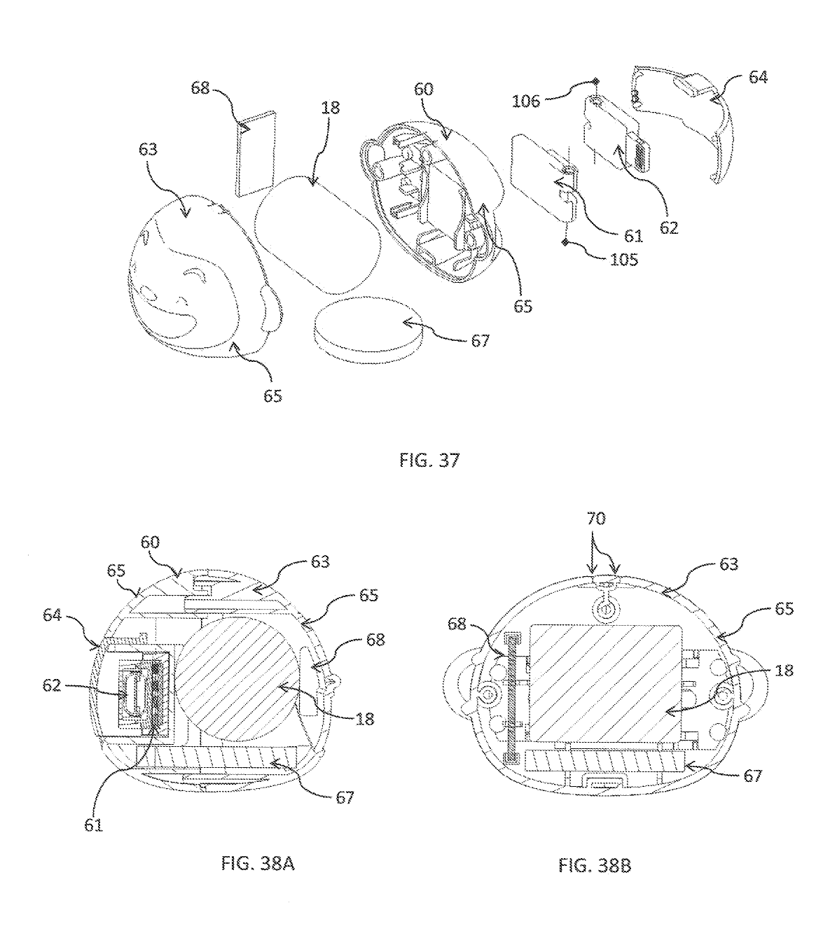

It will thus be understood that the fanciful or amusing housing assembly is cooperably associated or assembled with the adapter-circuit mount for enclosing the power source intermediate the adapter-circuit mount and the portions of the fanciful or amusing housing assembly such as the front cover element 63, and thus that the power source may well function to charge a select electronic device via at least one of the first or second adapters 61 and 62 when pivoted into a for-use configuration (generally depicted in FIG. 31-36) from the closed state or configuration (generally depicted in FIG. 27-30).

As indicated, the fanciful or amusing housing assembly preferably comprises hollow cover element 64, which hollow cover element 64 is displaceable relative to the outer housing surfacing 65 of the fanciful or amusing housing assembly for selectively exposing the adapter-receiving hollow construction 59 and enabling the first and second adapters 61 and 62 to pivot about the first and second pivot axes 105 and 106 into the for-use configuration as generally and comparatively depicted in FIG. 31-36. The hollow cover element 64 preferably comprises outer cover surfacing as at 66, which outer cover surfacing 66 is preferably flush with the outer housing surfacing 65 of the fanciful or amusing housing assembly when the novelty charger device 300 is in a fully closed configuration for resembling an anatomical (toy) head as has been generically depicted. Other possible head shapes are unlimited, and could conceivably include action figure heads such as Iron Man and/or other characters such as Hello Kitty, and the like.

Accordingly, while the foregoing specifications set forth certain specificity, the same should not be construed as setting forth limits to the invention but rather as setting forth certain preferred embodiments and features. For example, as prefaced hereinabove, it is contemplated that the present invention essentially provides a novelty charger device as variously exemplified at devices 100, 200, and 300 for charging an electronic device such as a smart phone 400 or a tablet type computer 401 or for communicatively linking two such devices as generally depicted in FIG. 42.

The novelty charger device according to the present invention may thus be said to preferably or essentially comprise a base construction, a circuit assembly, and a cover construction. The base construction preferably comprises a bottom portion and opposed end portions. The end portions extend away from the bottom portion, and at least one select basal portion comprises an adapter-receiving cavity, the at least one select basal portion being selected from the group consisting of the bottom and end portions.

The circuit assembly comprises a power source and at least one, but preferably two or first and second pivotal adapter elements. The power source and the at least one pivotal adapter element being in electrical communication with one another. The cover construction shrouds the circuit assembly and is attachable to the base construction such that the at least one or each pivotal adapter element is pivotally receivable in an adapter-receiving cavity. The cover construction is thus cooperable with the base construction for enclosing the power source intermediate the base and cover constructions. The enclosed power source thus charges a select electronic device via the at least one pivotal adapter element.

The at least one select basal portion may preferably comprise at least two select basal portions. The at least two select basal portions are selected from the group consisting of the bottom portion and at least one of the end portions. The circuit assembly comprises at least two pivotal adapter elements, which two pivotal adapter elements are pivotally receivable in at least two adapter-receiving cavities. When so configured, the novelty charger device may thus further communicate at least two electronic devices.

The at least two pivotal adapter elements each comprise a pivot axis, which pivot axes are preferably parallel to one another. A first pivot axis enables rotation of a first pivotal adapter element through at least 180 rotational degrees and a second pivot axis enables rotation of a second pivotal adapter element through at least 90 rotational degrees. The first and second pivotal adapter elements may thus extend in opposite directions relative to the base construction when pivoted to a fully extended for-use configuration.

The bottom portion preferably comprises outer bottom surfacing and a first select end portion as selected from the end portions preferably comprises outer first select end portion surfacing. The first and second pivotal adapter elements each comprise outer adapter surfacing. The outer bottom and first select end portion surfacing are flush with the outer adapter surfacing when the first and second pivotal adapter elements are in a closed position or configuration.

The circuit assembly may preferably comprise a switch for enabling various types of functions, and thus a switch-activating button is further contemplated. A second select end portion as selected from the end portions comprises a button-receiving aperture. The switch-activating button is receivable in the button-receiving aperture and is communicable with the switch for enabling button-actuable functionality of the novelty charger device.

The switch-activating button comprises outer button surfacing and the second select end portion comprises outer second select end portion surfacing. The outer button surfacing is flush with the outer second select end portion surfacing when the switch-activating button is in a relaxed or non-depressed state or configuration. The power source may preferably comprise a cylindrical outer surface and the cover construction may preferably comprise a U-shaped transverse cross-section. The U-shaped transverse cross-section thus provides an arcuate shroud over the power source via a semi-cylindrical upper portion of the cover construction.

Another novelty charger device according to the present invention may be said to provide functionality for charging an electronic device, and may be said to preferably or essentially comprise an adapter-circuit mount, a circuit assembly, and a fanciful or amusing housing assembly. The adapter-circuit mount preferably comprising an adapter-receiving hollow construction, which adapter-receiving hollow construction comprises a base portion and opposed wall portions. The wall portions extend from the base portion. The circuit assembly comprises a power source and at least one pivotal adapter element. The power source and the at least one pivotal adapter element are in electrical communication with one another.

The fanciful or amusing housing assembly preferably and essentially comprises a mount-adapter-cover assembly. The circuit assembly is cooperable with the adapter-circuit mount such that the at least one pivotal adapter element is pivotally receivable in the adapter-receiving hollow construction. The fanciful or amusing housing assembly is cooperable with the adapter-circuit mount for enclosing the power source within the fanciful or amusing housing assembly. The power source may thus be used to charge a select electronic device via the at least one pivotal adapter element when pivoted into a for-use configuration.

The novelty charger device may preferably comprise at least two pivotal adapter elements, which at least two pivotal adapter elements each are pivotally receivable in the adapter-receiving hollow construction. The novelty charger device may thus provide further functionality for communicating at least two electronic devices.

The fanciful or amusing housing assembly of the novelty charger device may preferably comprise a hollow cover element, which hollow cover element is displaceable relative to the mount-adapter-cover assembly for selectively exposing the adapter-receiving hollow construction and enabling each pivotal adapter element to pivot from a for-storage configuration to a for-use configuration. Each of the two pivotal adapter elements comprise a pivot axis, which pivot axes are preferably parallel to one another and extend orthogonally relative to the parallel wall portions.

Yet another novelty charger device according to the present invention may function to charge an electronic device or link or communicate two electronic devices. The novelty charger device according to the present invention may be said to preferably comprise a circuit assembly and a fanciful or amusing housing assembly, wherein the circuit assembly comprises a power source and at least one pivotal adapter element, the power source and the at least one pivotal adapter element being in electrical communication with one another.

The fanciful or amusing housing assembly of this novelty charger device may be said to preferably comprise an adapter-circuit mount and a mount-adapter-cover assembly. The adapter-circuit mount defines an adapter-receiving hollow construction, and the circuit assembly is cooperable with the adapter-circuit mount such that the at least one pivotal adapter element is pivotally receivable in the adapter-receiving hollow construction. The fanciful or amusing housing assembly is cooperable with the adapter-circuit mount for enclosing the power source within the housing assembly, and the novelty-enclosed power source thus for charging a select electronic device via the at least one pivotal adapter element when pivoted into a for-use configuration.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures, the appended claims and drawings.

We claim:

1. A novelty charger device for charging an electronic device, the novelty charger device comprising:
a base construction, the base construction comprising a bottom portion and opposed end portions, the end portions extending away from the bottom portion, at least one select basal portion comprising an adapter-receiving cavity, the at least one select basal portion being selected from the group consisting of the bottom and end portions;
a circuit assembly, the circuit assembly comprising a power source and at least one pivotal adapter element, the power source and the at least one pivotal adapter element being in electrical communication with one another; and
a cover construction, the circuit assembly being cooperable with the base construction such that the at least one pivotal adapter element is pivotally receivable in the at least one adapter-receiving cavity, the cover construction being cooperable with the base construction for enclosing the power source intermediate the base and cover constructions, the power source thus for charging a select electronic device via the at least one pivotal adapter element.

2. The novelty charger device of claim 1 wherein the at least one select basal portion comprises at least two select basal portions, the at least two select basal portions being selected from the group consisting of the bottom portion and at least one of the end portions, the circuit assembly comprising at least two pivotal adapter elements, the two pivotal adapter elements being pivotally receivable in at least two adapter-receiving cavities, said novelty charger device thus for further communicating at least two electronic devices.

3. The novelty charger device of claim 2 wherein the at least two pivotal adapter elements each comprise a pivot axis, the pivot axes being parallel to one another.

4. The novelty charger device of claim 3 wherein a first pivot axis enables rotation of a first pivotal adapter element through at least 180 rotational degrees and a second pivot axis enables rotation of a second pivotal adapter element through at least 90 rotational degrees.

5. The novelty charger device of claim 4 wherein the first and second pivotal adapter elements extend in opposite directions relative to the base construction when pivoted to a fully extended for-use configuration.

6. The novelty charger device of claim 2 wherein the bottom portion comprises outer bottom surfacing and a first select end portion as selected from the end portions comprises outer first select end portion surfacing, the first and second pivotal adapter elements each comprising outer adapter surfacing, the outer bottom and first select end portion surfacing being flush with the outer adapter surfacing when the at least two pivotal adapter elements are in a closed position.

7. The novelty charger device of claim 1 comprising a switch-activating button, the circuit assembly comprising a switch, a second select end portion as selected from the end portions comprising a button-receiving aperture, the switch-activating button being receivable in the button-receiving aperture and being communicable with the switch for enabling button-actuable functionality of the novelty charger device.

8. The novelty charger device of claim 7 wherein the switch-activating button comprises outer button surfacing and the second select end portion comprises outer second select end portion surfacing, the outer button surfacing being flush with the outer second select end portion surfacing when the switch-activating button is in a non-depressed state.

9. The novelty charger device of claim 1 wherein the power source comprises a cylindrical outer surface and the cover construction comprises a U-shaped transverse cross-section, the U-shaped transverse cross-section for providing an arcuate shroud over the power source.

10. A novelty charger device for charging an electronic device, the novelty charger device comprising:
an adapter-circuit mount, the adapter-circuit mount comprising an adapter-receiving hollow construction, the adapter-receiving hollow construction comprising a base portion and opposed wall portions, the wall portions extending from the base portion;
a circuit assembly, the circuit assembly comprising a power source and at least one pivotal adapter element, the power source and the at least one pivotal adapter element being in electrical communication with one another; and
a housing assembly, the housing assembly comprising a mount-adapter-cover assembly, the circuit assembly being cooperable with the adapter-circuit mount such that the at least one pivotal adapter element is pivotally receivable in the adapter-receiving hollow construction, the housing assembly being cooperable with the adapter-circuit mount for enclosing the power source within the housing assembly, the power source thus for charging a select electronic device via the at least one pivotal adapter element when pivoted into a for-use configuration.

11. The novelty charger device of claim 10 comprising at least two pivotal adapter elements, the at least two pivotal adapter elements each being pivotally receivable in the adapter-receiving hollow construction, said novelty charger device thus for further communicating at least two electronic devices.

12. The novelty charger device of claim 11 wherein the housing assembly comprises a hollow cover element, the hollow cover element being displaceable relative to the mount-adapter-cover assembly for selectively exposing the adapter-receiving hollow construction and enabling each pivotal adapter element to pivot from a for-storage configuration to a for-use configuration.

13. The novelty charger device of claim 12 wherein the at least two pivotal adapter elements each comprise a pivot axis, the pivot axes being parallel to one another.

14. The novelty charger device of claim 13 wherein each pivot axis is orthogonal to the wall portions.

15. The novelty charger device of claim 12 wherein the mount-adapter-cover assembly comprises outer assembly surfacing and the hollow cover element comprises outer cover surfacing, the outer assembly and cover surfacing being flush when the novelty charger device is in a fully closed configuration.

16. The novelty charger device of claim 10 comprising a switch-activating button, the circuit assembly comprises a switch, and the mount-adapter-cover assembly comprises a button-receiving aperture, the switch-activating button being receivable in the button-receiving aperture and being communicable with the switch for enabling button-actuable functionality of the novelty charger device.

17. The novelty charger device of claim 16 wherein the switch-activating button comprises outer button surfacing, the outer button surfacing being flush with the outer assembly surfacing when the switch-activating button is in non-depressed state.

18. A novelty charger device for charging an electronic device, the novelty charger device comprising:
a circuit assembly, the circuit assembly comprising a power source and at least one pivotal adapter element, the power source and the at least one pivotal adapter element being in electrical communication with one another; and
a housing assembly, the housing assembly comprising an adapter-circuit mount and a mount-adapter-cover assembly, the adapter-circuit mount defining an adapter-receiving hollow construction, the circuit assembly being cooperable with the adapter-circuit mount such that the at least one pivotal adapter element is pivotally receivable in the adapter-receiving hollow construction, the housing assembly being cooperable with the adapter-circuit mount for enclosing the power source within the housing assembly, the power source thus for charging a select electronic device via the at least one pivotal adapter element when pivoted into a for-use configuration.

19. The novelty charger device of claim 18 comprising at least two pivotal adapter elements, the at least two pivotal adapter elements each being pivotally receivable in the adapter-receiving hollow construction, said novelty charger device thus for further communicating at least two electronic devices.

20. The novelty charger device of claim 18 wherein the housing assembly comprises a hollow cover element, the hollow cover element being displaceable relative to the mount-adapter-cover assembly for selectively exposing the adapter-receiving hollow and enabling each pivotal adapter element to pivot into a for-use configuration.
